(19) United States
(12) Patent Application Publication
(10) Pub. No.: US 2018/0129742 A1
(43) Pub. Date: May 10, 2018

(54) NATURAL LANGUAGE OBJECT TRACKING

(71) Applicant: QUALCOMM Incorporated, San Diego, CA (US)

(72) Inventors: Zhenyang LI, Amsterdam (NL); Ran TAO, Amsterdam (NL); Efstratios GAVVES, Amsterdam (NL); Cornelis Gerardus Maria SNOEK, Volendam (NL); Arnold Wilhelmus Maria SMEULDERS, Amsterdam (NL)

(21) Appl. No.: 15/587,196

(22) Filed: May 4, 2017

Related U.S. Application Data
(60) Provisional application No. 62/420,510, filed on Nov. 10, 2016.

(51) Int. Cl. G06F 17/30; G06K 9/00; G06K 9/66

(52) U.S. Cl. CPC G06F 17/30796; G06F 17/30787; G06K 9/66; G06F 17/30696; G06K 9/00744; G06F 17/30663

(57) ABSTRACT

A method of tracking an object across a sequence of video frames using a natural language query includes receiving the natural language query and identifying an initial target in an initial frame of the sequence of video frames based on the natural language query. The method also includes adjusting the natural language query, for a subsequent frame, based on content of the subsequent frame and/or a likelihood of a semantic property of the initial target appearing in the subsequent frame. The method further includes identifying a text driven target and a visual driven target in the subsequent frame. The method still further includes combining the visual driven target with the text driven target to obtain a final target in the subsequent frame.

### CROSS-REFERENCE TO RELATED APPLICATION

The present application claims the benefit of U.S. Provisional Patent Application No. 62/420,510, filed on Nov. 10, 2016 and titled “NATURAL LANGUAGE OBJECT TRACKING,” the disclosure of which is expressly incorporated by reference herein in its entirety.

### BACKGROUND

### Field

Certain aspects of the present disclosure generally relate to object tracking and, more particularly, to using a natural language query to track an object.

### Background

Object tracking may be used for various applications in various devices, such as internet protocol (IP) cameras, Internet of Things (IoT) devices, autonomous cars, and/or service robots. The object tracking applications may include improved object perception and/or understanding of object paths for motion planning.

Object tracking localizes a target object in consecutive frames. The object tracker may be trained to track the object from a frame to a search region of a subsequent frame using various techniques. That is, an artificial neural network may match an image, such as an image in a bounding box, from a first frame to a search region of a second frame (e.g., subsequent frame).

Conventional object trackers are initialized when a user places a bounding box around a target (e.g., object) in a frame of a video. The bounding box may be manually placed around the target in an initial frame. The target is tracked through subsequent frames based on the bounding box.

Conventional recurrent neural networks can be used for a variety of tasks, such as image captioning and visual question answering. A recurrent neural network (e.g., artificial neural network (ANN)), which may comprise an interconnected group of artificial neurons (e.g., neuron models), is a computational device or represents a method to be performed by a computational device.

### SUMMARY

In one aspect of the present disclosure, a method of tracking an object across a sequence of video frames using a natural language query is presented. After receiving the natural language query, the method identifies an initial target in an initial frame of the sequence of video frames based on the natural language query. The method further includes adjusting the natural language query, for a subsequent frame, based on content of the subsequent frame and/or a likelihood of a semantic property of the initial target appearing in the subsequent frame. The method still further includes identifying a text driven target in the subsequent frame based on the adjusted natural language query. The method identifies a visual driven target in the subsequent frame based on the initial target in the initial frame. The method further combines the visual driven target with the text driven target to obtain a final target in the subsequent frame.

Another aspect of the present disclosure is directed to an apparatus including means for receiving the natural language query. The apparatus also includes means for identifying an initial target in an initial frame of the sequence of video frames based on the natural language query. The apparatus further includes means for adjusting the natural language query, for a subsequent frame, based on content of the subsequent frame and/or a likelihood of a semantic property of the initial target appearing in the subsequent frame. The apparatus still further includes means for identifying a text driven target in the subsequent frame based on the adjusted natural language query. The apparatus also includes means for identifying a visual driven target in the subsequent frame based on the initial target in the initial frame. The apparatus further includes means for combining the visual driven target with the text driven target to obtain a final target in the subsequent frame.

In another aspect of the present disclosure, a non-transitory computer-readable medium with non-transitory program code recorded thereon is disclosed. The program code for tracking an object across a sequence of video frames using a natural language query is executed by at least one processor and includes program code to receive the natural language query. The program code also includes program code to identify an initial target in an initial frame of the sequence of video frames based on the natural language query. The program code further includes program code to adjust the natural language query, for a subsequent frame, based on content of the subsequent frame and/or a likelihood of a semantic property of the initial target appearing in the subsequent frame. The program code still further includes program code to identify a text driven target in the subsequent frame based on the adjusted natural language query. The program code also includes program code to identify a visual driven target in the subsequent frame based on the initial target in the initial frame. The program code further includes program code to combine the visual driven target with the text driven target to obtain a final target in the subsequent frame.

Another aspect of the present disclosure is directed to an apparatus for tracking an object across a sequence of video frames using a natural language query, the apparatus having a memory unit and one or more processors coupled to the memory unit. The processor(s) is configured to receive the natural language query and to identify an initial target in an initial frame of the sequence of video frames based on the natural language query. The processor(s) is further configured to adjust the natural language query, for a subsequent frame, based on content of the subsequent frame and/or a likelihood of a semantic property of the initial target appearing in the subsequent frame. The processor(s) is still further configured to identify a text driven target in the subsequent frame based on the adjusted natural language query. The processor(s) is also configured to identify a visual driven target in the subsequent frame based on the initial target in the initial frame. The processor(s) is further configured to combine the visual driven target with the text driven target to obtain a final target in the subsequent frame.

Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 illustrates an example implementation of designing a neural network using a system-on-a-chip (SOC), including a general-purpose processor in accordance with certain aspects of the present disclosure.

FIG. 2 illustrates an example implementation of a system in accordance with aspects of the present disclosure.

FIG. 3A is a diagram illustrating a neural network in accordance with aspects of the present disclosure.

FIG. 3B is a block diagram illustrating an exemplary deep convolutional network (DCN) in accordance with aspects of the present disclosure.

FIG. 4 illustrates an example of object tracking according to aspects of the present disclosure.

FIG. 5 illustrates an example of natural language object retrieval according to aspects of the present disclosure.

FIG. 6 illustrates an example of natural language object tracking according to aspects of the present disclosure.

FIGS. 7 and 8 illustrate examples of a multiple pathway network according to aspects of the present disclosure.

FIG. 9 illustrates an example of a long short term memory (LSTM) network according to aspects of the present disclosure.

FIG. 10 illustrates an example of an attention model according to aspects of the present disclosure.

FIGS. 11, 12, and 13 illustrate examples of natural language object tracking according to aspects of the present disclosure.

FIG. 14 illustrates a flow diagram for tracking an object across a sequence of video frames using a natural language query according to aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method practiced using other structure, functionality, or structure and functionality in addition to or other than the various aspects of the disclosure set forth. It should be understood that any aspect of the disclosure disclosed may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the disclosure. Although some benefits and advantages of the preferred aspects are mentioned, the scope of the disclosure is not intended to be limited to particular benefits, uses or objectives. Rather, aspects of the disclosure are intended to be broadly applicable to different technologies, system configurations, networks and protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Natural language object retrieval learns a matching function between natural language queries and object segment appearances. Conventional systems rank image locations according to their fitting score with respect to a sentence description. As such, one sentence applies to one image. Aspects of the present disclosure disengage the sentence description from particular frames, which improves robustness of the tracking by language.

Conventional neural network architectures improve their parameters on training data during training using a maximum likelihood principle. The fixed parameters obtained during training may be applied on novel data. Some systems replace the static neural network parameters with dynamic parameters that depend on the current input. Aspects of the present disclosure use textual input to generate filters.

That is, aspects of the present disclosure improve object tracking by using natural language queries to track an object over multiple frames. In one configuration, an object tracking system integrates language and vision to improve specification of the target and to use the lingual specification of the target to aid the system during the target tracking.

Aspects of the present disclosure are directed to integrating natural language queries with object tracking. For example, the query, “follow the woman in the red dress,” provides a natural language description of an object in an image. Given the image and the query, aspects of the present disclosure localize the object with a bounding box and track the object through subsequent frames (e.g., images) of a sequence of frames.

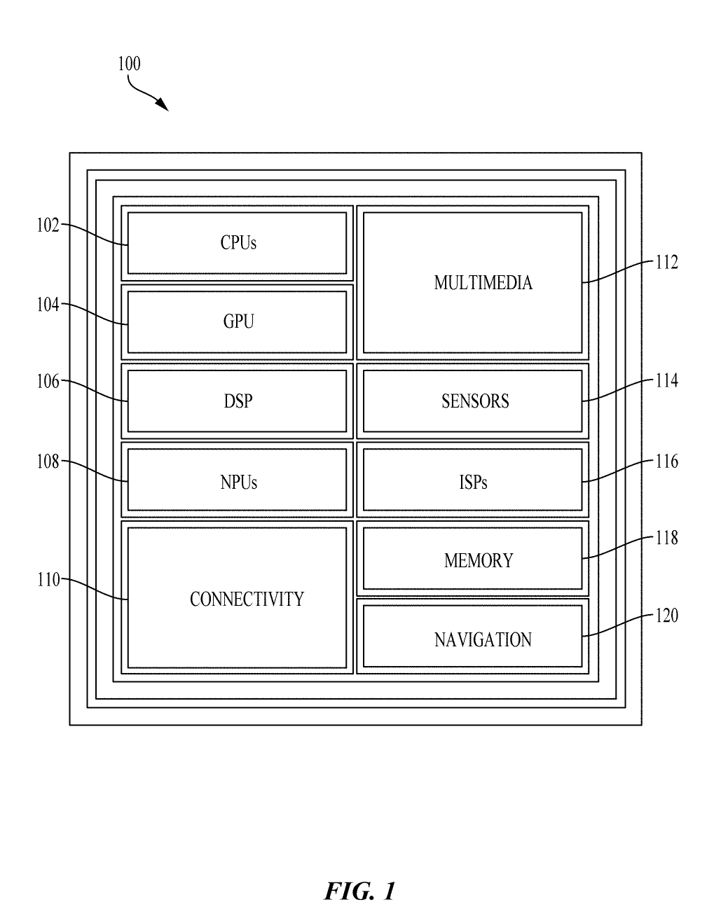

FIG. 1 illustrates an example implementation of the aforementioned natural language object tracking using a system-on-a-chip (SOC) 100, which may include a general-purpose processor (CPU) or multi-core general-purpose processors (CPUs) 102 in accordance with certain aspects of the present disclosure. Variables (e.g., neural signals and synaptic weights), system parameters associated with a computational device (e.g., neural network with weights), delays, frequency bin information, and task information may be stored in a memory block associated with a neural processing unit (NPU) 108, in a memory block associated with a CPU 102, in a memory block associated with a graphics processing unit (GPU) 104, in a memory block associated with a digital signal processor (DSP) 106, in a dedicated memory block 118, or may be distributed across multiple blocks. Instructions executed at the general-purpose processor 102 may be loaded from a program memory associated with the CPU 102 or may be loaded from a dedicated memory block 118.

The SOC 100 may also include additional processing blocks tailored to specific functions, such as a GPU 104, a DSP 106, a connectivity block 110, which may include fourth generation long term evolution (4G LTE) connectivity, unlicensed Wi-Fi connectivity, USB connectivity, Bluetooth connectivity, and the like, and a multimedia processor 112 that may, for example, detect and recognize gestures. In one implementation, the NPU is implemented in the CPU, DSP, and/or GPU. The SOC 100 may also include a sensor processor 114, image signal processors (ISPs) 116, and/or navigation 120, which may include a global positioning system.

The SOC may be based on an ARM instruction set. In an aspect of the present disclosure, the instructions loaded into the general-purpose processor 102 may comprise code for tracking an object across a sequence of video frames using a natural language query. The instructions loaded into the general-purpose processor 102 may also comprise code for receiving the natural language query. The instructions loaded into the general-purpose processor 102 may further comprise code for identifying an initial target in an initial frame of the sequence of video frames based on the natural language query. The instructions loaded into the general-purpose processor 102 may still further comprise code for adjusting the natural language query, for a subsequent frame, based on content of the subsequent frame and/or a likelihood of a semantic property (e.g., a visual feature) of the initial target appearing in the subsequent frame. The instructions loaded into the general-purpose processor 102 may also comprise code for identifying a text driven target in the subsequent frame based on the adjusted natural language query. The instructions loaded into the general-purpose processor 102 may further comprise code for identifying a visual driven target in the subsequent frame based on the initial target in the initial frame. The instructions loaded into the general-purpose processor 102 may still further comprise code for combining the visual driven target with the text driven target to obtain a final target in the subsequent frame.

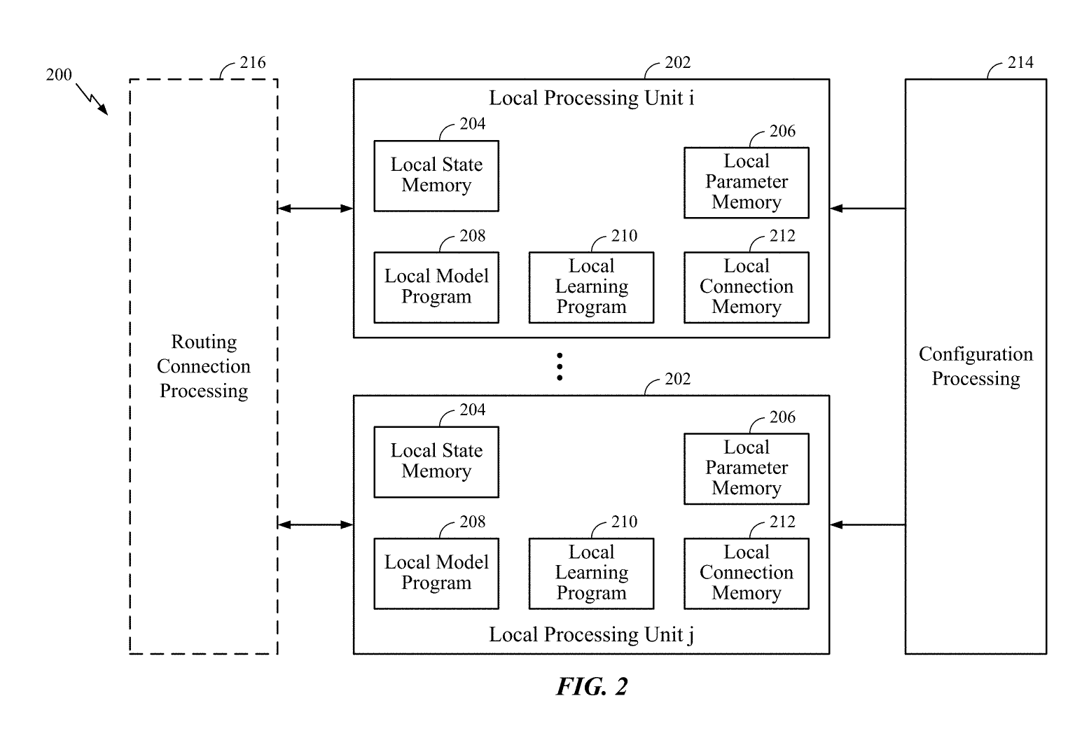

FIG. 2 illustrates an example implementation of a system 200 in accordance with certain aspects of the present disclosure. As illustrated in FIG. 2, the system 200 may have multiple local processing units 202 that may perform various operations of methods described herein. Each local processing unit 202 may comprise a local state memory 204 and a local parameter memory 206 that may store parameters of a neural network. In addition, the local processing unit 202 may have a local (neuron) model program (LMP) memory 208 for storing a local model program, a local learning program (LLP) memory 210 for storing a local learning program, and a local connection memory 212. Furthermore, as illustrated in FIG. 2, each local processing unit 202 may interface with a configuration processor unit 214 for providing configurations for local memories of the local processing unit, and with a routing connection processing unit 216 that provides routing between the local processing units 202.

In one configuration, a processing model is configured to receive the natural language query and identify an initial target in an initial frame of the sequence of video frames based on the natural language query. The model is also configured to adjust the natural language query, for a subsequent frame, based on content of the subsequent frame and/or a likelihood of a semantic property of the initial target appearing in the subsequent frame. The model is further configured to identify a visual driven target in the subsequent frame based on the initial target in the initial frame, and to combine the visual driven target with the text driven target to obtain a final target in the subsequent frame. The model includes a receiving means, identifying means, adjusting means, and/or combining means. In one configuration, the receiving means, identifying means, adjusting means, and/or combining means may be the general-purpose processor 102, program memory associated with the general-purpose processor 102, memory block 118, local processing units 202, and or the routing connection processing units 216 configured to perform the functions recited. In another configuration, the aforementioned means may be any module or any apparatus configured to perform the functions recited by the aforementioned means.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

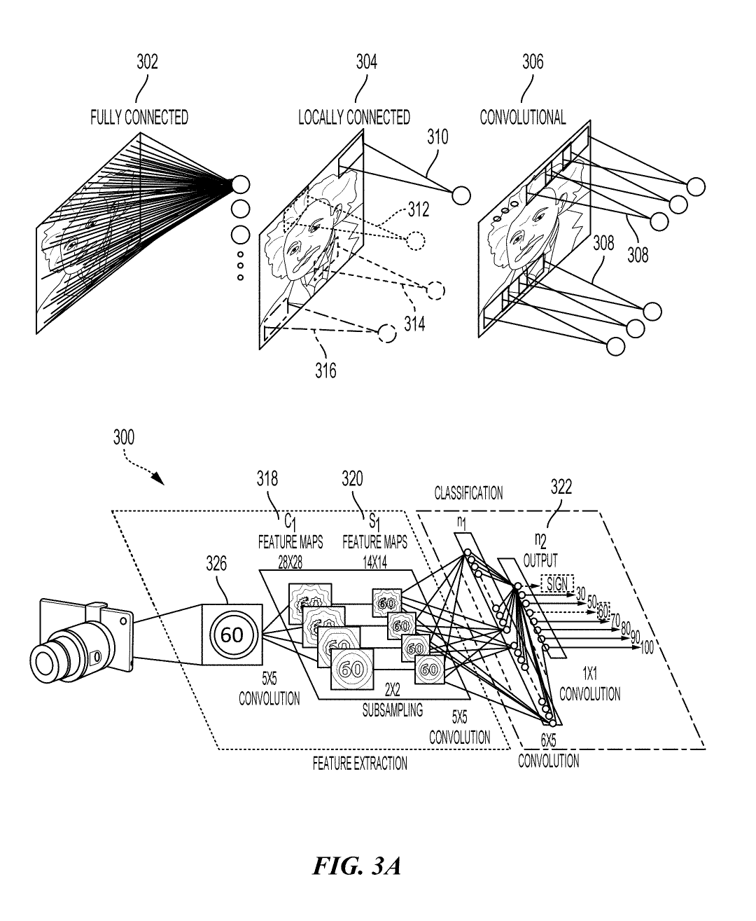

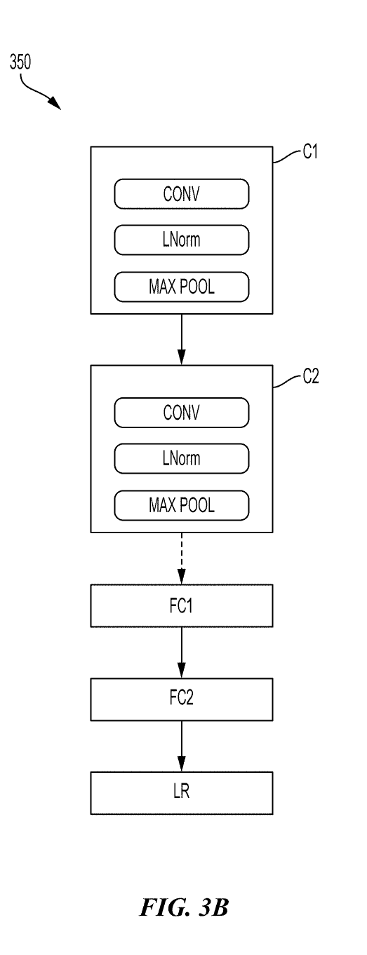

Referring to FIG. 3A, the connections between layers of a neural network may be fully connected 302 or locally connected 304. In a fully connected network 302, a neuron in a first layer may communicate its output to every neuron in a second layer, so that each neuron in the second layer will receive input from every neuron in the first layer. Alternatively, in a locally connected network 304, a neuron in a first layer may be connected to a limited number of neurons in the second layer. A convolutional network 306 may be locally connected, and is further configured such that the connection strengths associated with the inputs for each neuron in the second layer are shared (e.g., 308). More generally, a locally connected layer of a network may be configured so that each neuron in a layer will have the same or a similar connectivity pattern, but with connections strengths that may have different values (e.g., 310, 312, 314, and 316). The locally connected connectivity pattern may give rise to spatially distinct receptive fields in a higher layer, because the higher layer neurons in a given region may receive inputs that are tuned through training to the properties of a restricted portion of the total input to the network.

Locally connected neural networks may be well suited to problems in which the spatial location of inputs is meaningful. For instance, a network 300 designed to recognize visual features from a car-mounted camera may develop high layer neurons with different properties depending on their association with the lower versus the upper portion of the image. Neurons associated with the lower portion of the image may learn to recognize lane markings, for example, while neurons associated with the upper portion of the image may learn to recognize traffic lights, traffic signs, and the like.

A DCN may be trained with supervised learning. During training, a DCN may be presented with an image, such as a cropped image of a speed limit sign 326, and a “forward pass” may then be computed to produce an output 322. The output 322 may be a vector of values corresponding to features such as “sign,” “60,” and “100.” The network designer may want the DCN to output a high score for some of the neurons in the output feature vector, for example the ones corresponding to “sign” and “60” as shown in the output 322 for a network 300 that has been trained. Before training, the output produced by the DCN is likely to be incorrect, and so an error may be calculated between the actual output and the target output. The weights of the DCN may then be adjusted so that the output scores of the DCN are more closely aligned with the target.

To adjust the weights, a learning algorithm may compute a gradient vector for the weights. The gradient may indicate an amount that an error would increase or decrease if the weight were adjusted slightly. At the top layer, the gradient may correspond directly to the value of a weight connecting an activated neuron in the penultimate layer and a neuron in the output layer. In lower layers, the gradient may depend on the value of the weights and on the computed error gradients of the higher layers. The weights may then be adjusted so as to reduce the error. This manner of adjusting the weights may be referred to as “back propagation” as it involves a “backward pass” through the neural network.

In practice, the error gradient of weights may be calculated over a small number of examples, so that the calculated gradient approximates the true error gradient. This approximation method may be referred to as stochastic gradient descent. Stochastic gradient descent may be repeated until the achievable error rate of the entire system has stopped decreasing or until the error rate has reached a target level.

After learning, the DCN may be presented with new images 326 and a forward pass through the network may yield an output 322 that may be considered an inference or a prediction of the DCN.

Deep convolutional networks (DCNs) are networks of convolutional networks, configured with additional pooling and normalization layers. DCNs have achieved state-of-the-art performance on many tasks. DCNs can be trained using supervised learning in which both the input and output targets are known for many exemplars and are used to modify the weights of the network by use of gradient descent methods.

DCNs may be feed-forward networks. In addition, as described above, the connections from a neuron in a first layer of a DCN to a group of neurons in the next higher layer are shared across the neurons in the first layer. The feed-forward and shared connections of DCNs may be exploited for fast processing. The computational burden of a DCN may be much less, for example, than that of a similarly sized neural network that comprises recurrent or feedback connections.

The processing of each layer of a convolutional network may be considered a spatially invariant template or basis projection. If the input is first decomposed into multiple channels, such as the red, green, and blue channels of a color image, then the convolutional network trained on that input may be considered three-dimensional, with two spatial dimensions along the axes of the image and a third dimension capturing color information. The outputs of the convolutional connections may be considered to form a feature map in the subsequent layer 318 and 320, with each element of the feature map (e.g., 320) receiving input from a range of neurons in the previous layer (e.g., 318) and from each of the multiple channels. The values in the feature map may be further processed with a non-linearity, such as a rectification, max(0,x). Values from adjacent neurons may be further pooled, which corresponds to down sampling, and may provide additional local invariance and dimensionality reduction. Normalization, which corresponds to whitening, may also be applied through lateral inhibition between neurons in the feature map.

FIG. 3B is a block diagram illustrating an exemplary deep convolutional network 350. The deep convolutional network 350 may include multiple different types of layers based on connectivity and weight sharing. As shown in FIG. 3B, the exemplary deep convolutional network 350 includes multiple convolution blocks (e.g., C1 and C2). Each of the convolution blocks may be configured with a convolution layer, a normalization layer (LNorm), and a pooling layer. The convolution layers may include one or more convolutional filters, which may be applied to the input data to generate a feature map. Although only two convolution blocks are shown, the present disclosure is not so limiting, and instead, any number of convolutional blocks may be included in the deep convolutional network 350 according to design preference. The normalization layer may be used to normalize the output of the convolution filters. For example, the normalization layer may provide whitening or lateral inhibition. The pooling layer may provide down sampling aggregation over space for local invariance and dimensionality reduction.

The parallel filter banks, for example, of a deep convolutional network may be loaded on a CPU 102 or GPU 104 of an SOC 100, optionally based on an ARM instruction set, to achieve high performance and low power consumption. In alternative embodiments, the parallel filter banks may be loaded on the DSP 106 or an ISP 116 of an SOC 100. In addition, the DCN may access other processing blocks that may be present on the SOC, such as processing blocks dedicated to sensors 114 and navigation 120.

The deep convolutional network 350 may also include one or more fully connected layers (e.g., FC1 and FC2). The deep convolutional network 350 may further include a logistic regression (LR) layer. Between each layer of the deep convolutional network 350 are weights (not shown) that are to be updated. The output of each layer may serve as an input of a succeeding layer in the deep convolutional network 350 to learn hierarchical feature representations from input data (e.g., images, audio, video, sensor data and/or other input data) supplied at the first convolution block C1.

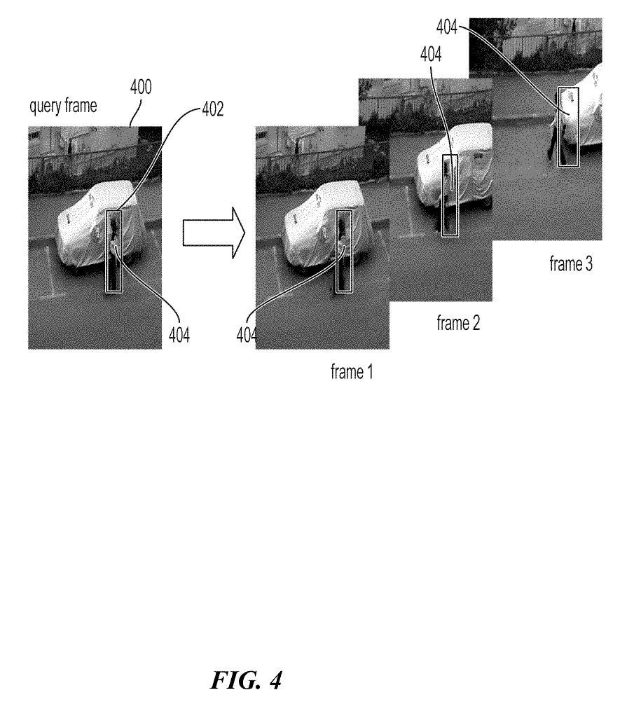

FIG. 4 illustrates an example of conventional object tracking. As shown in FIG. 4, at a first frame 400 (e.g., query frame), a bounding box 402 is placed around an object 404 to be tracked. The bounding box 402 may be provided via user input or may be provided via other methods for specifying a bounding box. Using the bounding box 402 as a guideline, the object tracking system tracks the object 404 in subsequent frames (e.g., frames 1-3).

### Natural Language Object Tracking

Conventional systems specify a target based on a user input bounding box. That is, a user manually inputs a bounding box around the object and the object (e.g., target) is tracked as it moves throughout the video (e.g., sequence of frames). Aspects of the present disclosure are directed to object tracking in video based on a natural language query. Aspects of the present disclosure do not use a user input bounding box for object tracking. Rather, in one configuration, given a frame from a video and a natural language expression as a query, the visual target described by the query is identified in the frame.

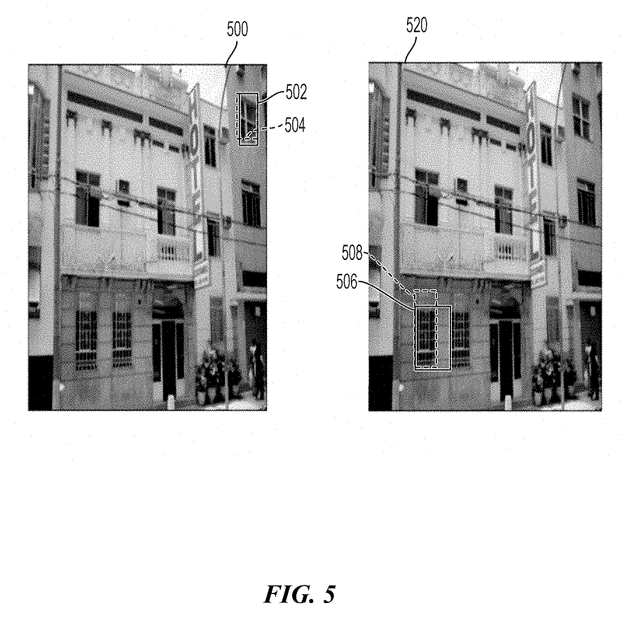

FIG. 5 illustrates an example of natural language object retrieval according to an aspect of the present disclosure. In a first image 500, a first natural language query may be “locate a window in the upper right of the image.” As shown in FIG. 5, in response to the first natural language query, the natural language object retrieval system generates a prediction 502 of the location of the window. A ground truth bounding box 504 is also indicated. The ground truth bounding box 504 may be used for training via back-propagation. Additionally, or alternatively, the ground truth bounding box 504 may be used to indicate where, in the frame, to search for the target based on the query.

As another example, in a second image 520, a second natural language query may be “locate a window in the bottom left of the image.” In response to the second natural language query, the natural language object retrieval system generates a prediction 506 of the location of the window. A ground truth bounding box 508 is also indicated. The ground truth bounding box 508 may be used for training via back-propagation. In the present application, a natural language query may be referred to as a query. After training a natural language object retrieval system, the natural language object retrieval system may be used for object tracking. The natural language object retrieval system may be a component of an object tracking system.

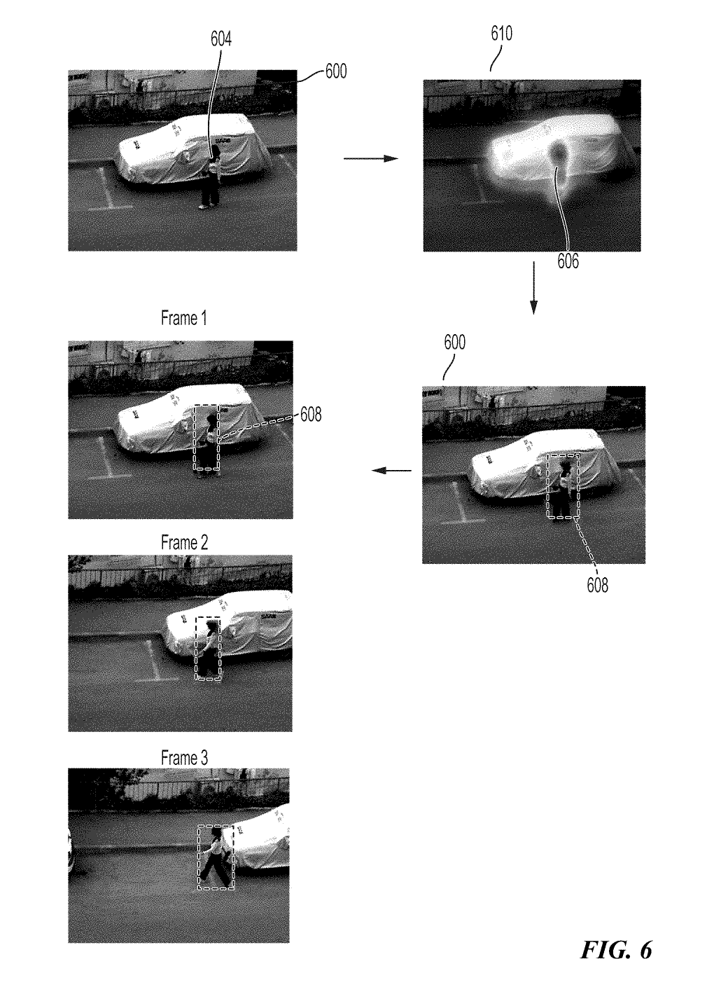

FIG. 6 illustrates an example of natural language object tracking according to aspects of the present disclosure. The natural language object tracking may be referred to as natural language tracking. As shown in FIG. 6, a user may provide a natural language query at a query frame 600. In this example, the query is “track the woman in the pink top next to the car.” Based on the query, the natural language tracking system generates a saliency map 610 (e.g., response map) of the query frame 600 to infer the location of a target (e.g., object) 604.

The location of the target 604 is inferred based on the activations of the saliency map 610. As shown in FIG. 6, an inferred location 606 of the target 604 is the location of the highest activations of the saliency map 610. After inferring the location 606 of the target 604, the natural language object tracking system generates a bounding box 608 around the target 604 in the query frame 600. The bounding box 608 may be used to track the target 604 in subsequent frames (e.g., frames 1-3).

In one configuration, the query is extended beyond the query frame to future frames (e.g., frames after the query frame). That is, while tracking the target 604, the natural language object tracking system uses the query to maintain the bounding box 608 around the target 604 in view of image noise and/or object variation in later frames. In another configuration, the natural language object tracking system may track multiple objects matching the query. In yet another configuration, if more than one object is tracked in response to the query, an additional query may be provided to refine the tracking to one object. The additional query may be provided in response to a prompt from the network.

In one configuration, a multiple pathway artificial neural network is used for object tracking. The network may include a query pathway (e.g., text driven branch) for processing the target description provided by the user. The query pathway may use an attention long short term memory (LSTM) network. The network may also include a target pathway (e.g., visual driven branch) that visually processes the query target. A context pathway may also be specified to convolve the visual features of the current frame with the filters generated from the query pathway and the target pathway. The context pathway may use a convolutional neural network (CNN), such as a deep convolutional neural network.

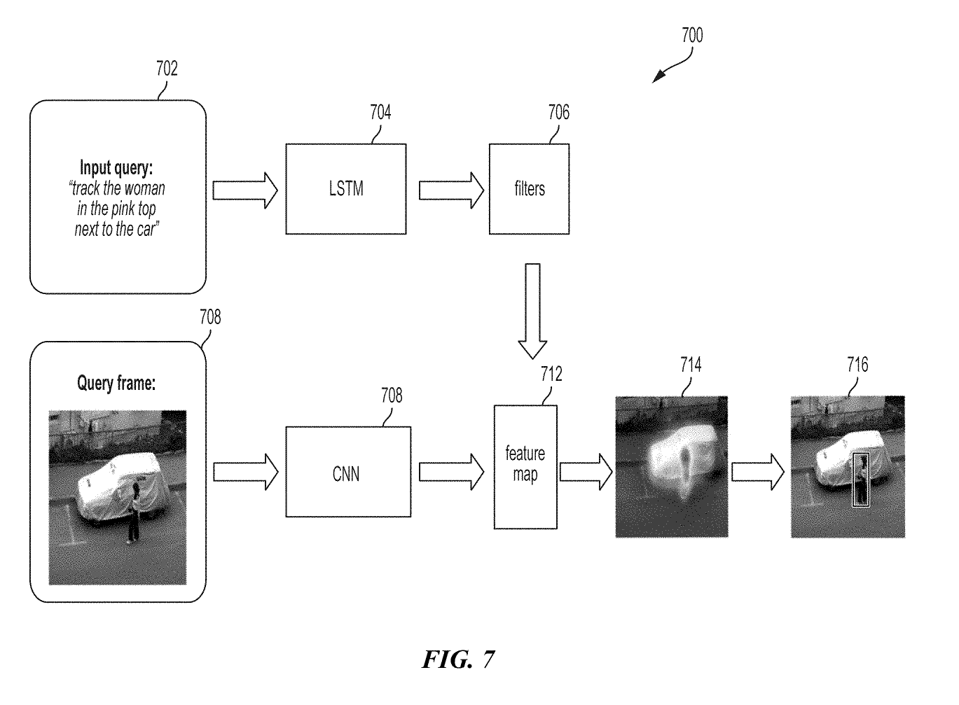

FIG. 7 illustrates an example of a portion of a multiple pathway network 700 according to aspects of the present disclosure. The architecture of FIG. 7 may be used for identifying a visual target at an initial frame (e.g., query frame). As show in FIG. 7, a user provides a natural language query at block 702. In this example, the natural language query is “track the woman in the pink top next to the car.” The natural language query may be vocalized to an object tracker or manually input by a device, such as a keyboard.

In one configuration, after receiving the natural language query, each word of the query is embedded into a vector and each vector is input to a recurrent neural network, such as a long short term memory (LSTM) network (block 704). The long short term memory network generates filters, such as visual filters (e.g., text driven visual filters), by encoding each received vector (block 706).

Additionally, as shown in FIG. 7, the query frame (block 708) is input to a neural network (block 710), such as a deep convolutional neural network (CNN), to generate a feature map (block 712) of the query frame (e.g., initial frame). That is, the convolutional neural network extracts the visual feature map of the input frame (e.g., query frame of FIG. 7). To enable the model to consider the spatial relationships, such as “car in the middle,” the spatial coordinates (x, y) of each position may be added as additional channels to the feature maps. Relative coordinates may be used by normalizing the relative coordinates into (−1, +1). The augmented feature map may include both local visual and spatial descriptors.

At block 714, a saliency map (e.g., response map) is generated by convolving the feature map (I) (block 712) with the visual filters (block 706). In one configuration, a dynamic convolutional layer is used to convolve the feature map (I) (block 712) with the visual filters (block 706). The convolutional filters may be dynamically determined based on different input information. The target information may be encoded by the query representation (s=h_{T}) generated from the long short term memory network. Furthermore, visual filters may be generated from the query (e.g., language expression). A single layer perceptron may be used to transform the semantic information from the generated representation (s) into the corresponding visual information as convolutional filters (e.g., dynamic filters) (v):

v=σ(Wᵥs+bᵥ) (1)

where σ is the sigmoid function, and v has the same number of channels as the image feature map I. The parameter Wᵥ is a weight matrix and bᵥ is the bias of the network. The dynamic filters may be specific filters determined by the semantic information from that query. That is, the dynamic filters may be different from the general filters used in conventional convolutional neural networks. For example, the phrase “track the red dog” will generate visual filters focusing on “red” and “dog.” That is, in one configuration, in contrast to conventional systems, the convolutional neural network does not to learn general convolution filters. For the query frame, aspects of the present disclosure generate the visual filters from the query.

In one configuration, the augmented image feature map I is convolved with the generated dynamic filters (v):

A=v*I (2)

where A is the response map including classification scores for each location in the feature map. A bounding box location of the target is then generated in the query frame described based on the language expression input. That is, at block 716, a likely location of the target is estimated based on the activations of the saliency map. In one configuration, the area having the highest activation is estimated as the location of the target.

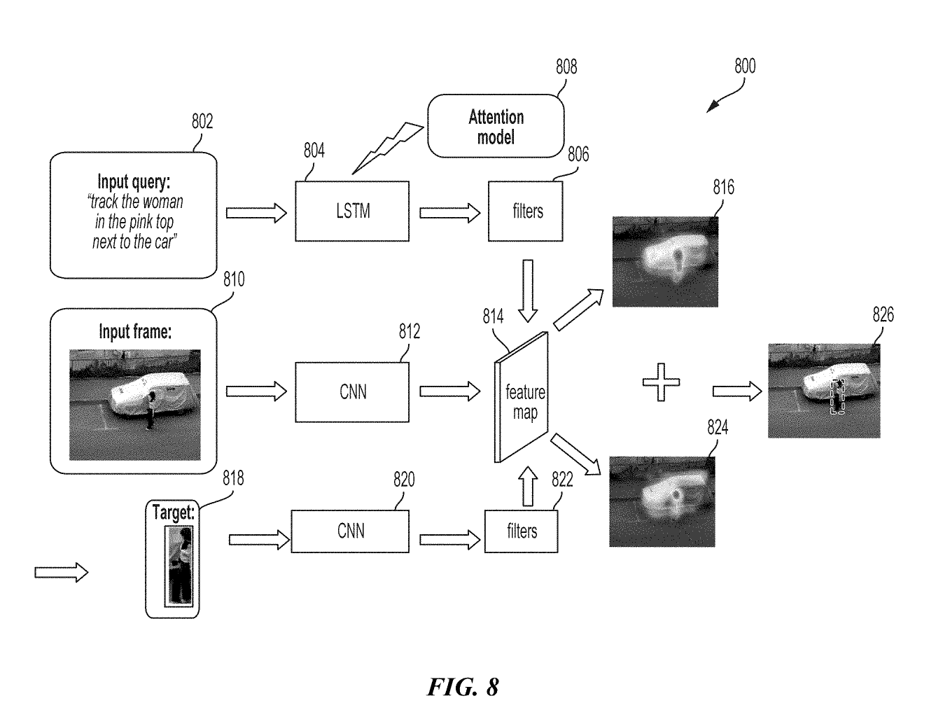

As previously discussed, to take advantage of both visual features of the target and linguistic features of the query, starting from a frame subsequent to the query frame, a three branch network may be used. As shown in FIG. 8, one branch (e.g., text driven branch) receives the query as an input and generates a response map of the target. Another branch (e.g., visual driven branch) receives the bounding box location previously identified in the query frame and uses the visual features of the target from the query frame to localize the target in the input frame (e.g., current frame). A third branch (e.g., context branch) convolves the visual features of the current frame with the filters generated from the text driven branch and the visual driven branch.

FIG. 8 illustrates an example of a multiple pathway network 800 according to aspects of the present disclosure. As shown in FIG. 8, at block 802, the query is received. The query is the same query that was received for determining the location of the target in the initial frame (FIG. 7). Each word of the query is embedded into a vector and each vector is input to a long short term memory (LSTM) network (block 804). The long short term memory network generates text driven filters (block 806) by encoding the vectors.

The query may be specified according to a query frame. Still, the object(s) in the frame may change after the query frame. Therefore, the text driven filters may be dynamic filters. For example, the query “woman in pink top next to a car” used in the query frame may be true if the woman is near a car in the query frame. However, if the woman is walking, she may eventually move away from the car. Therefore, an attention model may selectively focus on parts of the query, which are more likely to be consistent throughout the video.

In one configuration, the text driven filters are adjusted based on an attention model (block 808). The attention model may give greater weight to words in the query that are more likely to be consistent (e.g., present) in subsequent frames of the video, such as “woman” and “pink top” as opposed to “next to the car.” That is, the target's clothing (pink top) and gender (woman) have a higher probability of remaining the same throughout the video in comparison to the object's location (next to the car). In this example, the words “woman” and “pink top” are given a higher weight than “next to the car.”

The attention model may also adjust the weights based on the content of the subsequent frame. That is, if the network 800 detects that a target and/or or content of the subsequent frame has changed, the network may adjust the weights accordingly. For example, the woman in the pink top may put on a black jacket that covers the pink top. In this example, given the content of the current frame, the attention model may adjust the weight given to “pink top.” For example, the weight may be lowered or set to zero.

Additionally, as shown in FIG. 8, the input frame (e.g., current frame) (block 810) is input to a convolution layer of an artificial neural network (block 812), such as a deep convolutional neural network, to generate a feature map (block 814) of the input frame. The input frame is a frame that is after the initial frame. At block 816, a first saliency map (e.g., query response map) is generated by convolving the text driven filters (block 806) with the feature map (block 814). The convolving may be performed based on EQUATION 2.

At block 818, the multiple pathway network 800 also receives the identified target of the query frame. The target from the query frame is input to an artificial neural network, such as a deep convolutional neural network (block 820) to extract semantic, such as visual features, for the target in the query frame. The features are used to generate visual driven filters (block 822). Compared with the text driven branch, which transforms the linguistic features into dynamic filters, the visual driven branch uses the visual features of the target of the query frame as dynamic filters. The feature map is convolved with the dynamic filters of the visual driven branch. The convolving may be performed based on EQUATION 2.

Aspects of the present disclosure improve target tracking by using visual driven filters (block 822) in addition to text driven filters (block 806). For input frames after the query frame, the identified target from the query frame is used to generate visual driven filters to mitigate tracking false positives. For example, at a later time, another woman in a pink top may appear. In this example, the woman in the pink top may have some visual similarities to the original target. In a system that only relies on filters generated from the natural language query, the system may track the new woman in addition to the original woman. That is, the system would track all the women in pink tops. According to aspects of the present disclosure, the visual driven filters generated from the target frame alleviate problems that may arise from one or more similar targets entering a frame.

The visual driven filters (block 822) are convolved with the feature map (block 814) to generate a second saliency map (block 824) (e.g., target response map). The first saliency map (block 816) and the second saliency map (block 824) may be combined to generate a bounding box prediction of the target location in the current frame (block 826). The process is repeated for each frame of the sequence of frames specified for tracking the target.

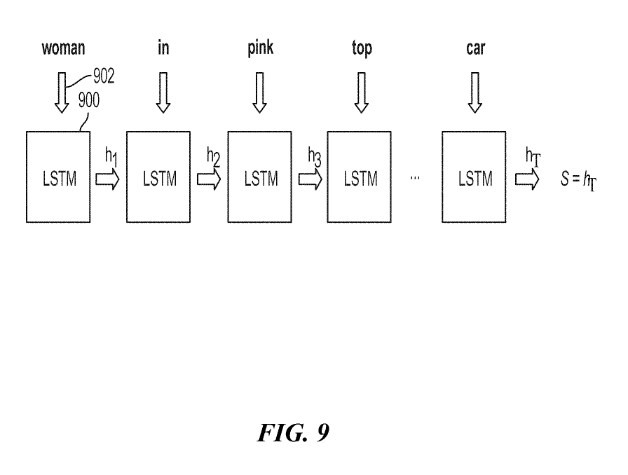

As discussed above, each word of the query is embedded into a vector that is input to a long short term memory network. The output of the long short term memory network is a hidden state (hₜ), which is a sentence (s) representation. FIG. 9 illustrates an example of a conventional long short term memory network 900. As shown in FIG. 9, a vector 902 for each word of the query is input to the long short term memory network 900. A hidden state (hₜ) is generated for each word and each time step (t). The combined hidden states (hₜ) are a sentence representation (s). That is, the hidden state h_{T} at the final time step T is selected as the representation of the entire expression (e.g., query).

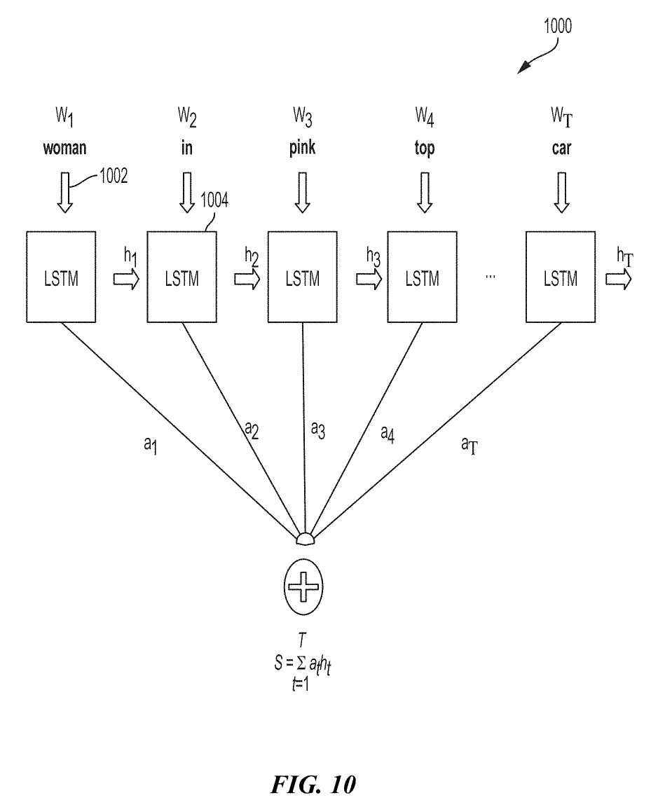

As discussed in relation to FIG. 8, in one configuration, an attention model is used to adjust the weights given to each word in the query. The adjusted weights may modify the filters generated by the long short term memory network. FIG. 10 illustrates an example of an attention model 1000 according to aspects of the present disclosure. As shown in the attention model 1000, a vector 1002 for each word of the query is input to the long short term memory network 1004 and the long short term memory network 1004 scans the embedded sequence to generate hidden states (hₜ) (t=1, . . . , T) from the word sequence.

As shown in FIG. 10, each word is given a weight (aₜ). At each time step (t), the weight (aₜ) is combined with the hidden state (hₜ). The sum of the combined weights and hidden states (aₜ hₜ) is used to calculate the sentence representation (s). That is, instead of using the hidden state at the final time step, the sentence representation(s) (e.g., expression representation) is generated as a weighted sum of the hidden states:

s=Σₜ₌₁^{T}aₜhₜ (3)

The sentence representation (s) focuses on words with a greater weight. That is, the weights (aₜ) (t=1, . . . , T) indicate the word importance. The weights may be adjusted based on a likelihood of a semantic property of the initial target being present in future frames and/or the content of the current frame. In one configuration, the weights are computed by a multi-layer perceptron conditioned on the hidden state at each word position and the visual features of the target (z) (e.g., visual features of the target identified in the query frame):

$$\begin{matrix}{\tilde{α}}_{t} = {W}_{α} ϕ ( {W}_{h} {h}_{t} + {W}_{z} z + b ) {b}_{α} & ( 4 ) \\ {α}_{t} = P ( t \vert {h}_{t} , z ) = \frac{exp ( {\tilde{α}}_{t} )}{{\sum }_{k = 1}^{T} exp ( {\tilde{α}}_{k} )} & ( 5 )\end{matrix}$$

where ϕ is the rectified linear unit (ReLU) and the attention weights are normalized using a normalized exponential function (e.g., softmax). The parameters W_{α}, Wₕ, W_{z} are weight matrices, and b, b_{α} are biases of the multi-layer perceptron. The attention weights may be generated by matching the visual target with the word sequence at each word position. As a result, the words corresponding to the target object properties are more likely to be selected rather than the context information in the expression. After obtaining the attention weighted representations for the query, a response map may be generated.

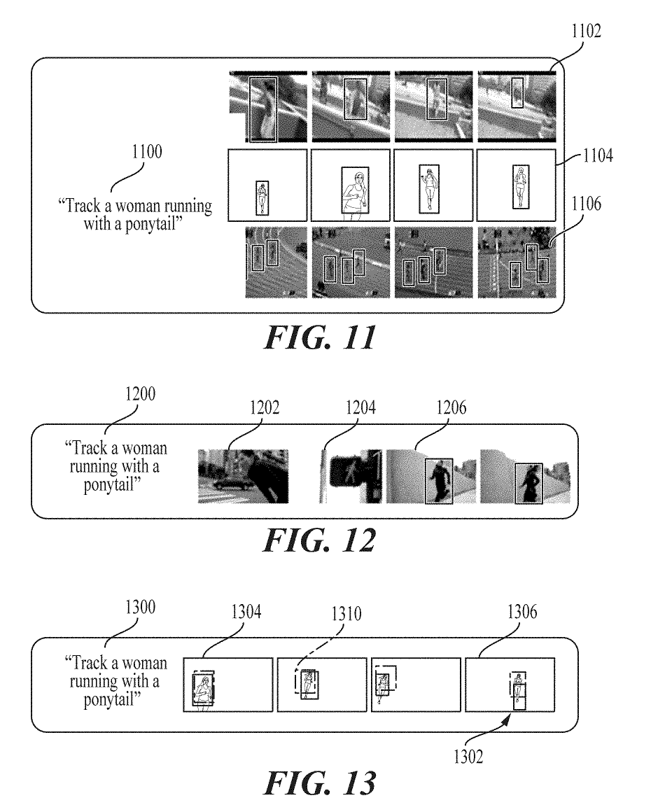

In conventional systems, the target defined by the bounding box is tracked in a single video. According to aspects of the present disclosure, the query is simultaneously executed on multiple videos. For example, the query may be used on all video feeds at a stadium to track a desired individual. FIG. 11 illustrates an example of tracking multiple videos using a single query 1100. In this example, the query “track a woman running in a ponytail” is simultaneously applied to a first video 1102, a second video 1104, and a third video 1106.

In conventional systems, the bounding box definition is applied to a particular object in a particular frame, such as the first frame in the sequence of frames. According to aspects of the present disclosure, a query is applied to any of the frames in a sequence of frames (e.g., video). Furthermore, in this configuration, the query may be inactive for several frames and the tracking may be autonomously initiated when a relevant object reappears. For example, the tracking may be used to track objects in live streaming, where a user may not be constantly monitoring the stream to define the target.

FIG. 12 illustrates an example of autonomously initiating a query 1200 when a relevant object appears. As shown in FIG. 12, the user may input the query “track a woman running in a ponytail” for a video. The first frame 1202 and the second frame 1204 of the video do not include the object (“woman running in a ponytail”). Therefore, the query 1200 is inactive for the first frame 1202 and the second frame 1204. The query 1200 is initialized at the third frame 1206 when the object appears in the frame 1206. As shown in FIG. 12, although the query 1200 is executed on a video, the query 1200 is inactive until the object (e.g., target) appears in a frame of the video. In the present example, the user may execute the query prior to the start of the video or at any time after the video has started. Furthermore, the user may execute the query and stop monitoring the stream. The network may notify the user of a match to the query when a target is identified.

In conventional systems, over time, a tracker may drift. For example, when an object is being tracked, there may be a difference in a similarity of the target from a first frame to a subsequent frame. The target similarity may be different due to a change in lighting, a change in target orientation, and/or image noise. The different similarity may cause the prediction to drift. In one configuration, the query is applied to each frame to operate as a semantic regularization for mitigating drifting. Furthermore, the language description may guide a standard tracker to avoid online updates when the object is not present in the image, because the semantic property of the initial target may be more likely to be consistent throughout the video than its visual appearance.

FIG. 13 illustrates an example of using a query 1300 to operate as a regularizer to mitigate drifting. As shown in FIG. 13, a conventional bounding box 1302 may drift away from a target between a first frame 1304 and a fourth frame 1306. As discussed above, the drifting may be caused due to the changes in appearance between the target in a frame and a subsequent frame. Additionally, as previously discussed, in one configuration, when predicting the location of the target in the current frame, a visual driven filter and a text driven filter are used to generate different saliency maps. The location of the target may be predicted based on the combination of saliency maps. As shown in FIG. 13, by applying the text driven filters (e.g., query) and the visual driven filters (not shown) to each frame, the bounding box 1310 does not drift between the first frame 1304 and the fourth frame 1306.

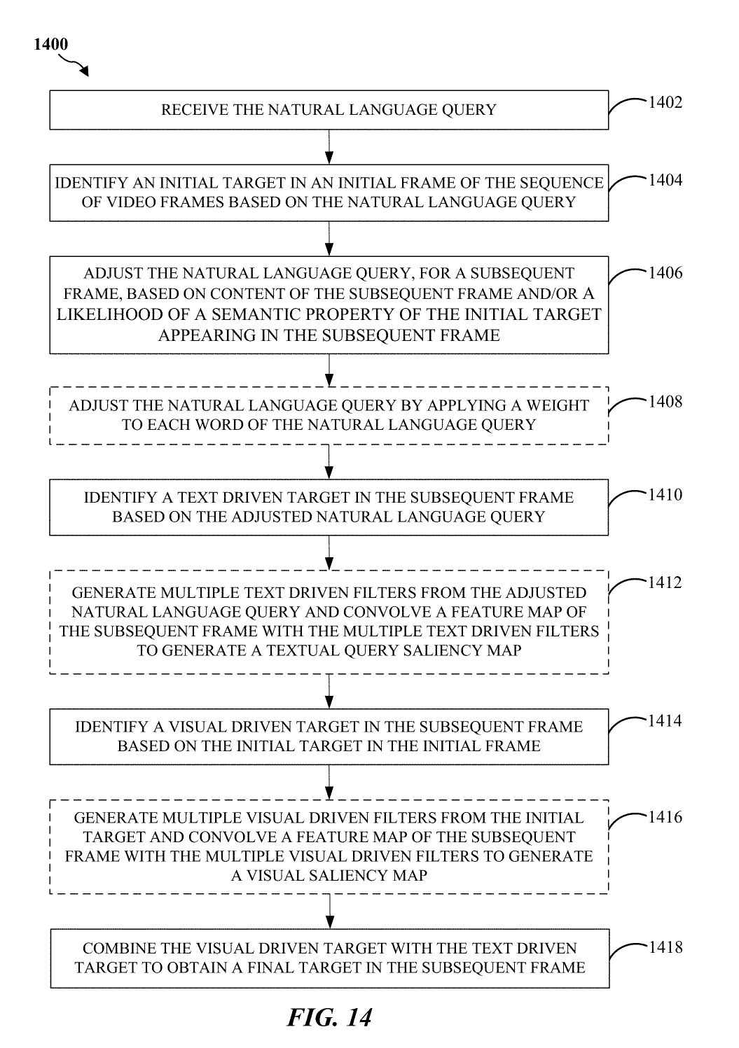

FIG. 14 illustrates a method 1400 for tracking an object across a sequence of video frames using a natural language query. As shown in FIG. 14, at block 1402, an artificial neural network (ANN) receives the natural language query. The natural language query may be in the form of natural language, such as “track the woman in the pink top next to the car.” At block 1404, the artificial neural network identifies an initial target in an initial frame of the sequence of video frames based on the natural language query. The initial target may be identified by embedding each word into a vector and inputting each vector into a recurrent neural network, such as a long short term memory (LSTM) network. The long short term memory network may generate text driven filters (e.g., text driven visual filters) by encoding the vectors with the long short term memory network. The output of the long short term memory network is a hidden state, which indicates a sentence representation.

The initial frame (e.g., query frame) may be input to a neural network such as a deep convolutional neural network (CNN). The deep convolutional neural network generates a feature map of the initial frame. The feature map may be convolved with the text driven filters to generate a response map (e.g., saliency map). The location of the target is predicted based on the response map. That is, the areas of the response map with the highest activations may be predicted as the location of the target. In one configuration, a target is then localized with a bounding box.

At block 1406, the artificial neural network adjusts the natural language query, for a subsequent frame, based on content of the subsequent frame and/or a likelihood of a semantic property of the initial target appearing in the subsequent frame. In addition to, or alternate from, the semantic property, aspects of the present disclosure may consider the visual features of the initial target. In an optional configuration, at block 1408, the artificial neural network adjusts the natural language query by applying a weight to each word of the natural language query. The weights may be generated based on the content of the subsequent frame and/or a likelihood of a semantic property of the initial target appearing in the subsequent frame. For example, for the query “woman in pink top and black pants next to white car,” the gender (woman) and clothing (pink top) have a lower probability of changing in comparison to the woman's location (next to white car). The words with a low probability of changing are given a higher weight. Additionally, the target may change from the initial frame to a subsequent frame and the weight applied to each word is adjusted to account for the change of appearance. For example, in the initial frame, the woman is wearing a pink top. In a subsequent frame, the woman may put on a black jacket, which covers the pink top. Because the woman is no longer wearing the pink top, the weight given to the phrase pink top is adjusted. For example, the weight may be lowered or set to zero, such that the words “woman” and “black pants” are deemed the most relevant. The natural language query may be adjusted by the weights based on the content of the subsequent frame. Furthermore, the natural language query may be adjusted by the weights based on a likelihood of a semantic property of the initial target being present in subsequent frames.

At block 1410, the artificial neural network identifies a text driven target in the subsequent frame based on the adjusted natural language query. In an optional configuration, at block 1412, the artificial neural network generates multiple text driven filters from the adjusted natural language query and convolves a feature map of the subsequent frame with the multiple text driven filters to generate a textual query saliency map. In one configuration, the text driven target is identified based on the textual query saliency map.

At block 1414, the artificial neural network identifies a visual driven target in the subsequent frame based on the initial target in the initial frame. In an optional configuration, at block 1416, the artificial neural network generates multiple visual driven filters from the initial target and convolves a feature map of the subsequent frame with the multiple visual driven filters to generate a visual saliency map. In one configuration, the visual driven target is identified based on the visual saliency map.

Finally, at block 1418, the artificial neural network combines the visual driven target with the text driven target to obtain a final target in the subsequent frame. The final target may be localized in the subsequent frame with a bounding box.

The method 1400 may be performed by the SOC 100 (FIG. 1) or the system 200 (FIG. 2). That is, each of the elements of the method 1400 may, for example, but without limitation, be performed by the SOC 100 or the system 200 or one or more processors (e.g., CPU 102 and local processing unit 202) and/or other components included therein.

The various operations of methods described above may be performed by any suitable means capable of performing the corresponding functions. The means may include various hardware and/or software component(s) and/or module(s), including, but not limited to, a circuit, an application specific integrated circuit (ASIC), or processor. Generally, where there are operations illustrated in the figures, those operations may have corresponding counterpart means-plus-function components with similar numbering.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a general-purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general-purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, erasable programmable read-only memory (EPROM), electrically erasable programmable read-only memory (EEPROM), registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described herein may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and general processing, including the execution of software stored on the machine-readable media. The processor may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, random access memory (RAM), flash memory, read only memory (ROM), programmable read-only memory (PROM), erasable programmable read-only memory (EPROM), electrically erasable programmable Read-only memory (EEPROM), registers, magnetic disks, optical disks, hard drives, or any other suitable storage medium, or any combination thereof. The machine-readable media may be embodied in a computer-program product. The computer-program product may comprise packaging materials.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or general register files. Although the various components discussed may be described as having a specific location, such as a local component, they may also be configured in various ways, such as certain components being configured as part of a distributed computing system.

The processing system may be configured as a general-purpose processing system with one or more microprocessors providing the processor functionality and external memory providing at least a portion of the machine-readable media, all linked together with other supporting circuitry through an external bus architecture. Alternatively, the processing system may comprise one or more neuromorphic processors for implementing the neuron models and models of neural systems described herein. As another alternative, the processing system may be implemented with an application specific integrated circuit (ASIC) with the processor, the bus interface, the user interface, supporting circuitry, and at least a portion of the machine-readable media integrated into a single chip, or with one or more field programmable gate arrays (FPGAs), programmable logic devices (PLDs), controllers, state machines, gated logic, discrete hardware components, or any other suitable circuitry, or any combination of circuits that can perform the various functionality described throughout this disclosure. Those skilled in the art will recognize how best to implement the described functionality for the processing system depending on the particular application and the overall design constraints imposed on the overall system.

The machine-readable media may comprise a number of software modules. The software modules include instructions that, when executed by the processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any medium that facilitates transfer of a computer program from one place to another. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Additionally, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method of tracking an object across a sequence of video frames using a natural language query, comprising:
receiving the natural language query;
identifying an initial target in an initial frame of the sequence of video frames based on the natural language query;
adjusting the natural language query, for a subsequent frame, based on at least one of a content of the subsequent frame, a likelihood of a semantic property of the initial target appearing in the subsequent frame, or a combination thereof;
identifying a text driven target in the subsequent frame based on the adjusted natural language query;
identifying a visual driven target in the subsequent frame based on the initial target in the initial frame; and
combining the visual driven target with the text driven target to obtain a final target in the subsequent frame.

2. The method of claim 1, further comprising adjusting the natural language query by applying a weight to each word of the natural language query, the weight generated based on at least one of the content of the subsequent frame, the likelihood of the semantic property of the initial target appearing in the subsequent frame, or a combination thereof.

3. The method of claim 1, further comprising:
generating a plurality of text driven filters from the adjusted natural language query; and
convolving a feature map of the subsequent frame with the plurality of text driven filters to generate a textual query saliency map, the text driven target identified based on the textual query saliency map.

4. The method of claim 1, further comprising:
generating a plurality of visual driven filters from the initial target; and
convolving a feature map of the subsequent frame with the plurality of visual driven filters to generate a visual saliency map, the visual driven target identified based on the visual saliency map.

5. The method of claim 1, further comprising bounding the initial target in the initial frame and the final target in the subsequent frame with a bounding box.

6. An apparatus for tracking an object across a sequence of video frames using a natural language query, the apparatus comprising:
a memory; and
at least one processor coupled to the memory, the at least one processor configured:
to receive the natural language query;
to identify an initial target in an initial frame of the sequence of video frames based on the natural language query;
to adjust the natural language query, for a subsequent frame, based on at least one of a content of the subsequent frame, a likelihood of a semantic property of the initial target appearing in the subsequent frame, or a combination thereof;
to identify a text driven target in the subsequent frame based on the adjusted natural language query;
to identify a visual driven target in the subsequent frame based on the initial target in the initial frame; and
to combine the visual driven target with the text driven target to obtain a final target in the subsequent frame.

7. The apparatus of claim 6, in which the at least one processor is further configured to adjust the natural language query by applying a weight to each word of the natural language query, the weight generated based on at least one of the content of the subsequent frame, the likelihood of the semantic property of the initial target appearing in the subsequent frame, or a combination thereof.

8. The apparatus of claim 6, in which the at least one processor is further configured:
to generate a plurality of text driven filters from the adjusted natural language query; and
to convolve a feature map of the subsequent frame with the plurality of text driven filters to generate a textual query saliency map, the text driven target identified based on the textual query saliency map.

9. The apparatus of claim 6, in which the at least one processor is further configured:
to generate a plurality of visual driven filters from the initial target; and
to convolve a feature map of the subsequent frame with the plurality of visual driven filters to generate a visual saliency map, the visual driven target identified based on the visual saliency map.

10. The apparatus of claim 6, in which the at least one processor is further configured to bound the initial target in the initial frame and the final target in the subsequent frame with a bounding box.

11. An apparatus for tracking an object across a sequence of video frames using a natural language query, comprising:
means for receiving the natural language query;
means for identifying an initial target in an initial frame of the sequence of video frames based on the natural language query;
means for adjusting the natural language query, for a subsequent frame, based on at least one of a content of the subsequent frame, a likelihood of a semantic property of the initial target appearing in the subsequent frame, or a combination thereof;
means for identifying a text driven target in the subsequent frame based on the adjusted natural language query;
means for identifying a visual driven target in the subsequent frame based on the initial target in the initial frame; and
means for combining the visual driven target with the text driven target to obtain a final target in the subsequent frame.

12. The apparatus of claim 11, further comprising means for adjusting the natural language query by applying a weight to each word of the natural language query, the weight generated based on at least one of the content of the subsequent frame, the likelihood of the semantic property of the initial target appearing in the subsequent frame, or a combination thereof.

13. The apparatus of claim 11, further comprising:
means for generating a plurality of text driven filters from the adjusted natural language query; and
means for convolving a feature map of the subsequent frame with the plurality of text driven filters to generate a textual query saliency map, the text driven target identified based on the textual query saliency map.

14. The apparatus of claim 11, further comprising:
means for generating a plurality of visual driven filters from the initial target; and
means for convolving a feature map of the subsequent frame with the plurality of visual driven filters to generate a visual saliency map, the visual driven target identified based on the visual saliency map.

15. The apparatus of claim 11, further comprising means for bounding the initial target in the initial frame and the final target in the subsequent frame with a bounding box.

16. A non-transitory computer-readable medium having program code recorded thereon for tracking an object across a sequence of video frames using a natural language query, the program code being executed by at least one processor and comprising:
program code to receive the natural language query;
program code to identify an initial target in an initial frame of the sequence of video frames based on the natural language query;
program code to adjust the natural language query, for a subsequent frame, based on at least one of a content of the subsequent frame, a likelihood of a semantic property of the initial target appearing in the subsequent frame, or a combination thereof;
program code to identify a text driven target in the subsequent frame based on the adjusted natural language query;
program code to identify a visual driven target in the subsequent frame based on the initial target in the initial frame; and
program code to combine the visual driven target with the text driven target to obtain a final target in the subsequent frame.

17. The non-transitory computer-readable medium of claim 16, in which the program code further comprises program code to adjust the natural language query by applying a weight to each word of the natural language query, the weight generated based on at least one of the content of the subsequent frame, the likelihood of the semantic property of the initial target appearing in the subsequent frame, or a combination thereof.

18. The non-transitory computer-readable medium of claim 16, in which the program code further comprises:
program code to generate a plurality of text driven filters from the adjusted natural language query; and
program code to convolve a feature map of the subsequent frame with the plurality of text driven filters to generate a textual query saliency map, the text driven target identified based on the textual query saliency map.

19. The non-transitory computer-readable medium of claim 16, in which the program code further comprises:
program code to generate a plurality of visual driven filters from the initial target; and
program code to convolve a feature map of the subsequent frame with the plurality of visual driven filters to generate a visual saliency map, the visual driven target identified based on the visual saliency map.

20. The non-transitory computer-readable medium of claim 16, in which the program code further comprises program code to bound the initial target in the initial frame and the final target in the subsequent frame with a bounding box.
